(19) United States
(12) Patent Application Publication
(10) Pub. No.: US 2015/0151201 A1
(43) Pub. Date: Jun. 4, 2015

(54) Holder for Smart Device

(71) Applicant: PATENT CATEGORY CORP., Walnut, CA (US)

(72) Inventor: Yu Zheng, Walnut, CA (US)

(73) Assignee: PATENT CATEGORY CORP., Walnut, CA (US)

(21) Appl. No.: 14/093,650

(22) Filed: Dec. 2, 2013

(51) Int. Cl. A63F 13/235; A63F 13/69; G06F 1/16

(52) U.S. Cl. CPC A63F 13/235; G06F 1/1613; A63F 13/69

(57) ABSTRACT

An assembly has a smart device, a play object having a base with a first connector on the base, and a holder having a frame section that securely receives and retains the housing of the smart device. The holder also has a support section extending from the frame section, the support section having a second connector that is adapted to couple to the first connector on the base

### BACKGROUND OF THE INVENTION

1. Field of the Invention

The present invention is directed to hand-held smart devices, and in particular, to a protective holder or case for use with tablets or smartphones.

2. Description of the Prior Art

Tablets and smartphones are widespread in today's society because of their portability and because they allow the user to transact so many aspects of their lives on them. One of the popular usages for tablets and smartphones is for gaming, and there are a variety of games that can be downloaded as “Apps” and played by the user.

### SUMMARY OF THE DISCLOSURE

It is one objective of the present invention to provide a holder for a tablet or smartphone that accommodates the coupling of play objects that can be used to enhance the gaming experience for the user.

To accomplish the objectives set forth above, the present invention provides an assembly having a smart device, a play object having a base with a first connector on the base, and a holder having a frame section that securely receives and retains the housing of the smart device. The holder also has a support section extending from the frame section, the support section having a second connector that is adapted to couple to the first connector on the base.

Circuitry can be provided in the base of the play objects, and in the support section, so that the identity of the play objects can be communicated from the base to the support section, and then from the support section to the smart device. The identity, and other data stored in these circuitries, can be used to enable activities and functionalities on the smart device.

### BRIEF DESCRIPTION OF THE DRAWINGS

FIG. 1 is a perspective view of a holder according to one embodiment of the present invention.

FIGS. 2A-2C illustrate three different play objects that can be coupled to the holder of FIG. 1.

FIG. 3 is an exploded perspective view illustrating the holder of FIG. 1, the play objects of FIGS. 2A-2C, and a tablet.

FIG. 4 illustrates the holder, play objects and tablet of FIG. 3 combined together in use.

FIG. 5 is an exploded perspective view of a holder according to another embodiment of the present invention.

FIGS. 6A-6C illustrate modifications that can be made to the play objects of FIGS. 2A-2C.

FIG. 7 is a schematic diagram for the system shown in FIG. 5.

FIG. 8 is an exploded perspective view illustrating a holder according to the present invention that is shown in use with a smartphone.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

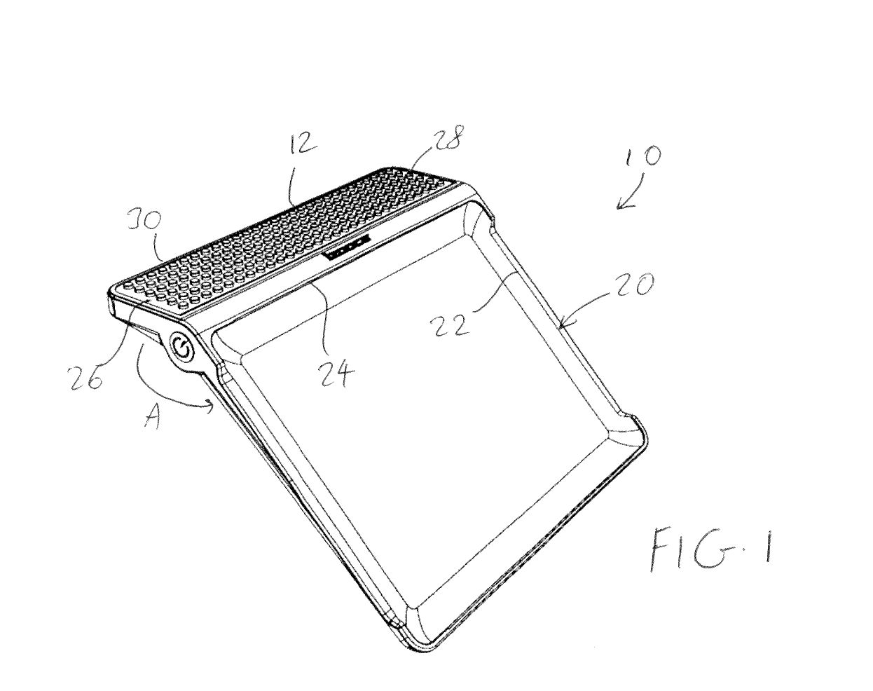

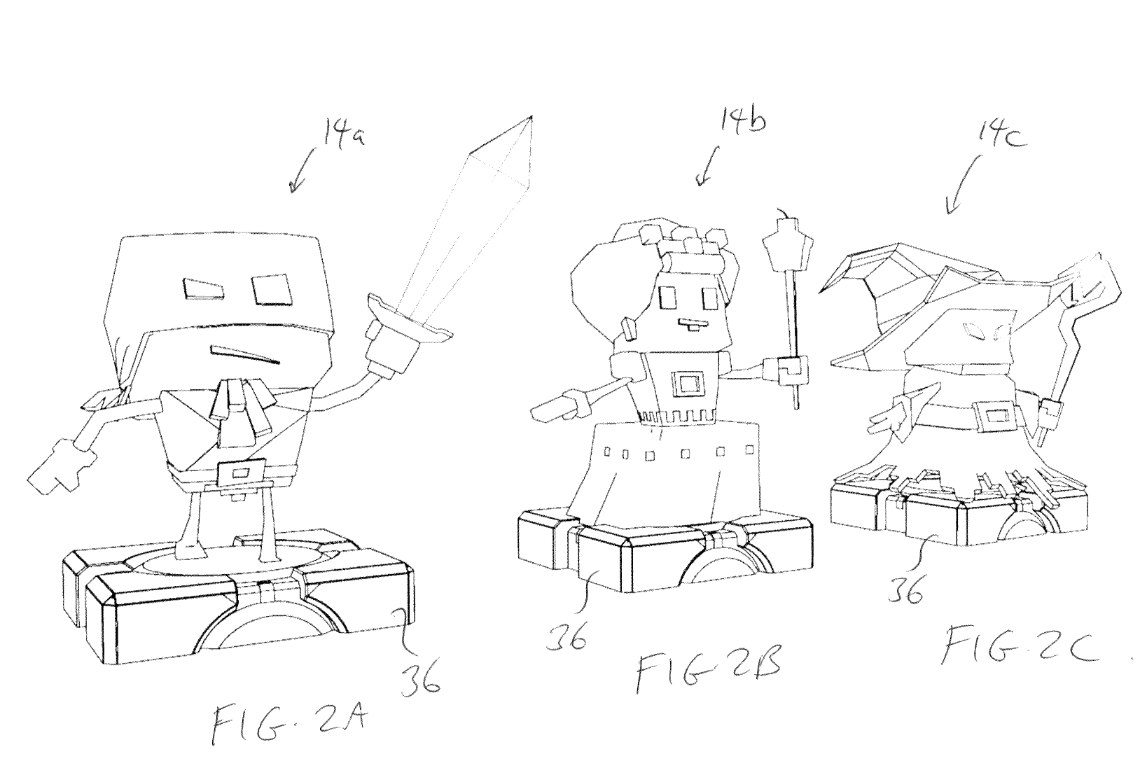

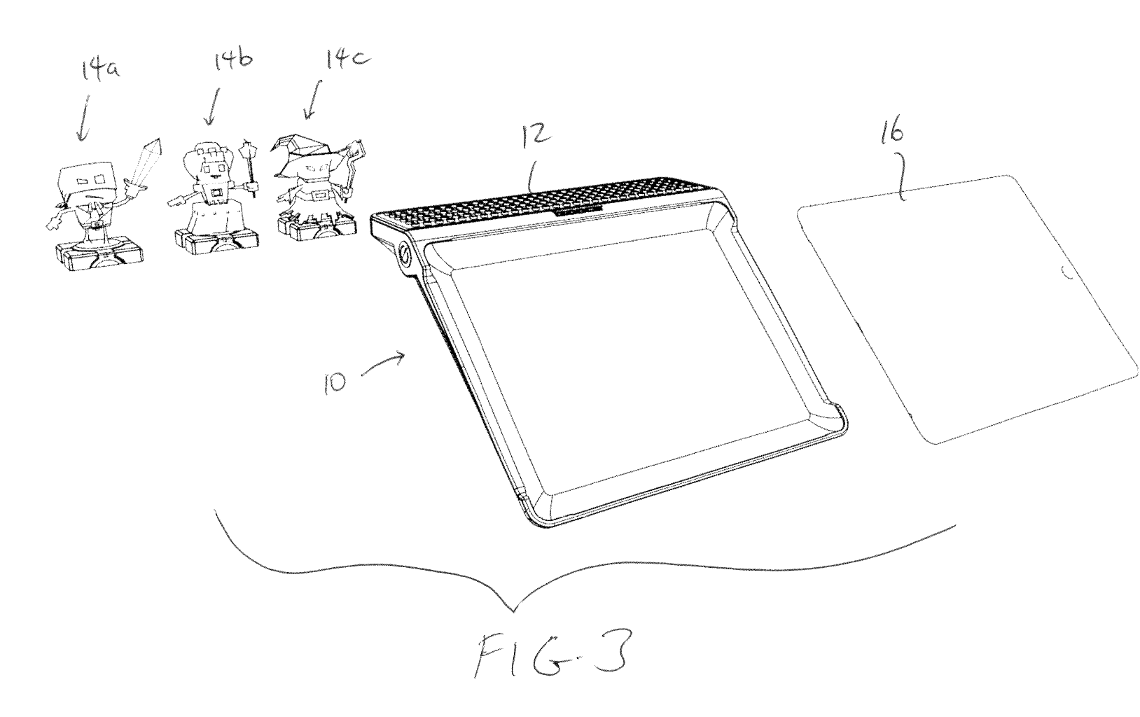

FIGS. 1-4 illustrate a holder 10 according to one embodiment of the present invention. The holder 10 has a support section 12 that allows a plurality of play objects 14a, 14b and 14c to be coupled thereto. An interactive computing device, such as a tablet 16, is received inside the holder 10. The tablet 16 can be any conventional tablet, such as an iPAD™ or other smart tablet.

The holder 10 has a four-sided frame section 20 that is sized, configured and adapted to surround a conventional tablet 16. The frame section 20 can be made from any solid material that is somewhat flexible, such as PVC, rubber, plastics and materials similar to those used for conventional smartphone protection cases. Flanges 22 can be provided along the internal edges of the frame section 20 and function to retain the housing of the tablet 16 inside the periphery of the frame section 20. Other techniques or mechanisms (e.g., VELCRO™ pads, ties, tabs, etc.) can also be used to retain the housing of the tablet 16 inside the periphery of the frame section 20.

The support section 12 can extend along any portion of one of the edges or sides of the frame section 20. For example, the support section 12 is shown as extending along the entire edge or side 24, but the support section 12 can also extend along a central portion, and not along the entire length, of the edge or side 24. The support section 12 can also be provided along another side or edge. The support section 12 defines a planar upper surface 26 that has a plurality of studs 28 provided thereon. The support section 12 and its studs 28 can be made of the same material as the frame section 20, or from a different material. The plane of the support section 12 is preferably positioned at an angle A away from the plane of the frame section 20. The angle A is preferably between 90 degrees and 180 degrees so that the support section 12 can be used to prop the tablet 16 at an angle for convenient viewing, with the rear edge 30 of the support section 12 contacting a table or other flat surface. It is also possible to provide the support section 12 separate from the frame section 20 so that the support section 12 is pivotable with respect to the frame section 20.

Each play object 14a-14c has a character or object that is supported on a base 36. The base 36 is adapted to be coupled to the studs 28 on the support section 20 in a manner that is similar to a LEGO™ connection. Specifically, most LEGO™ brick pieces have two basic components: studs on top and tubes on the inside. A brick's studs are slightly bigger than the space between the tubes and the walls. When the bricks are pressed together, the studs push the walls out and the tubes in. The material is resilient and wants to hold its original shape, so the walls and tubes press back against the studs. Friction also plays a role, preventing the two bricks from sliding apart. This stud-and-tube coupling system uses an interference fit, which provides a firm, friction-based connection between two parts without the use of an additional fastener. Thus, the bottom of the bases 36 would also include the tubes and walls that are normally found at the base of a conventional LEGO™ brick.

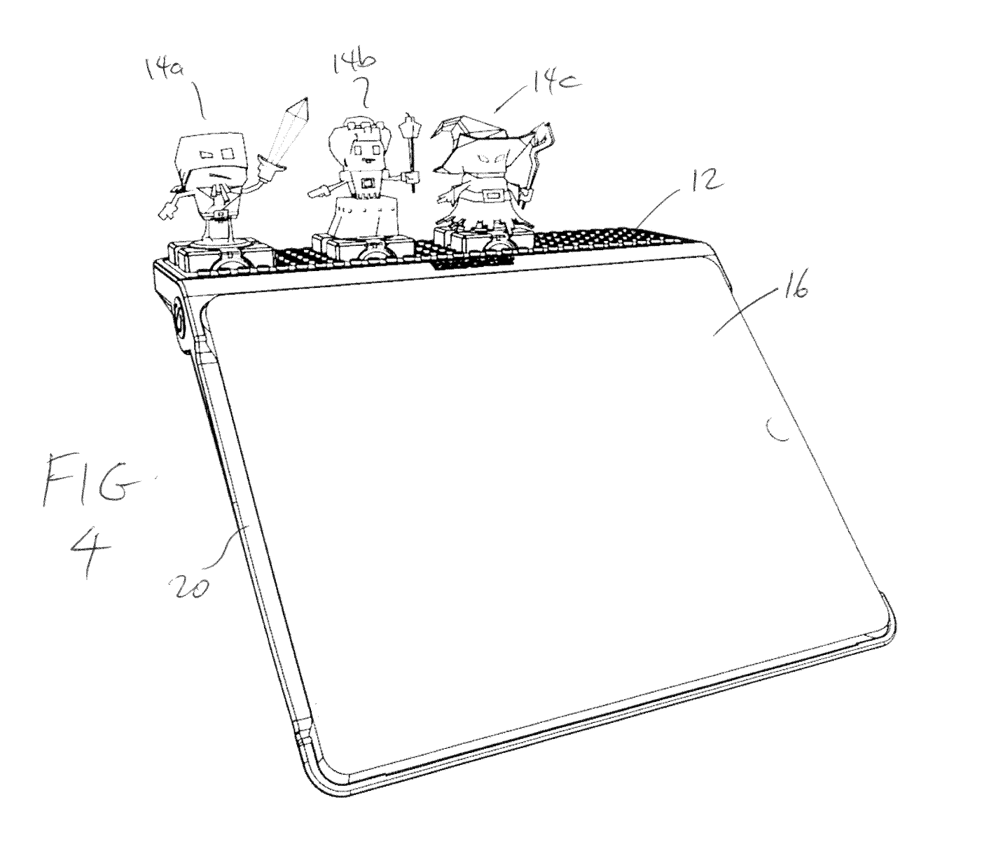

FIG. 4 illustrates a tablet 16 held in place inside the frame section 20, and the play objects 14a-14c coupled to the upper section 12. In this configuration, the user can play a game involving these play objects 14a-14c. For example, a user can use the tablet 16 to take a photo of any of these play objects 14a-14c, and the application that has been downloaded onto the tablet 16 can recognize the play objects 14a-14c from the photographed image(s) and enable the start of an activity (e.g., game, song, story, etc.) relating to the play objects 14a-14c. Alternatively, the holder 10 can be used solely as a toy holder for holding play objects 14a-14c. It is not necessary to place a smart device in the frame section 20.

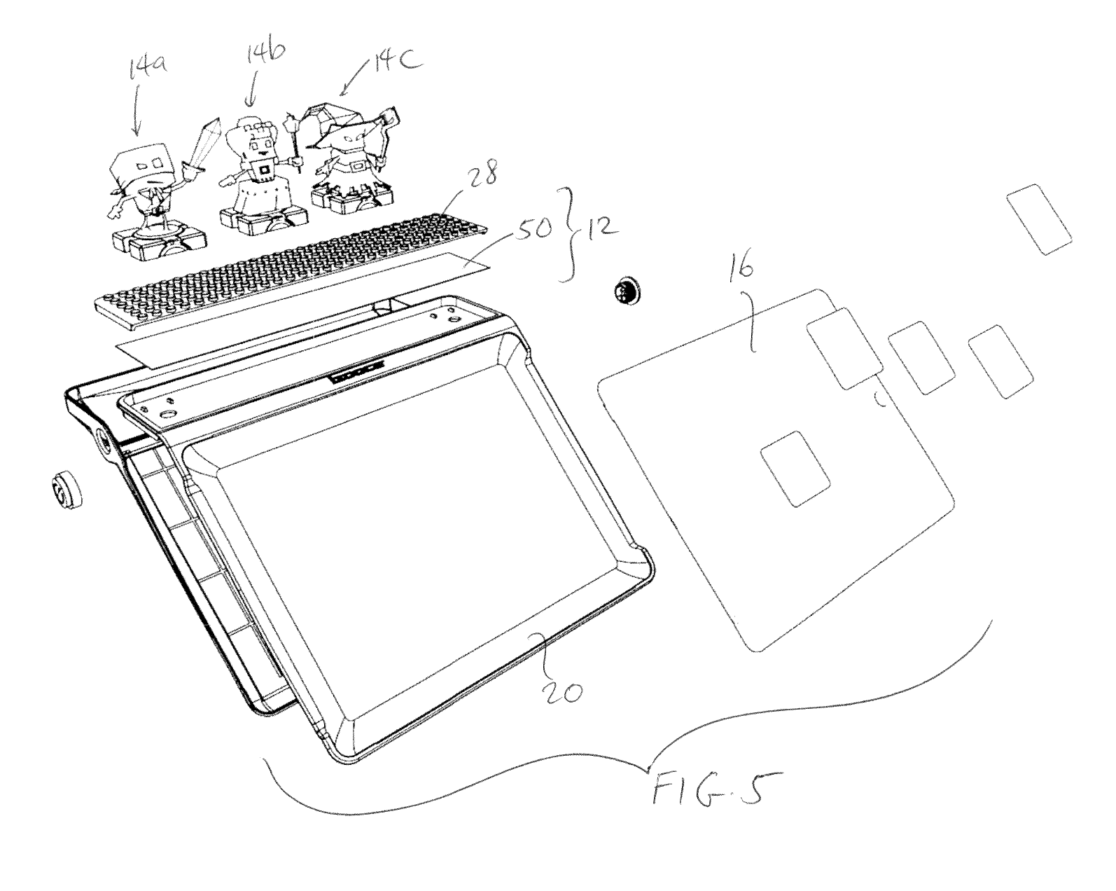

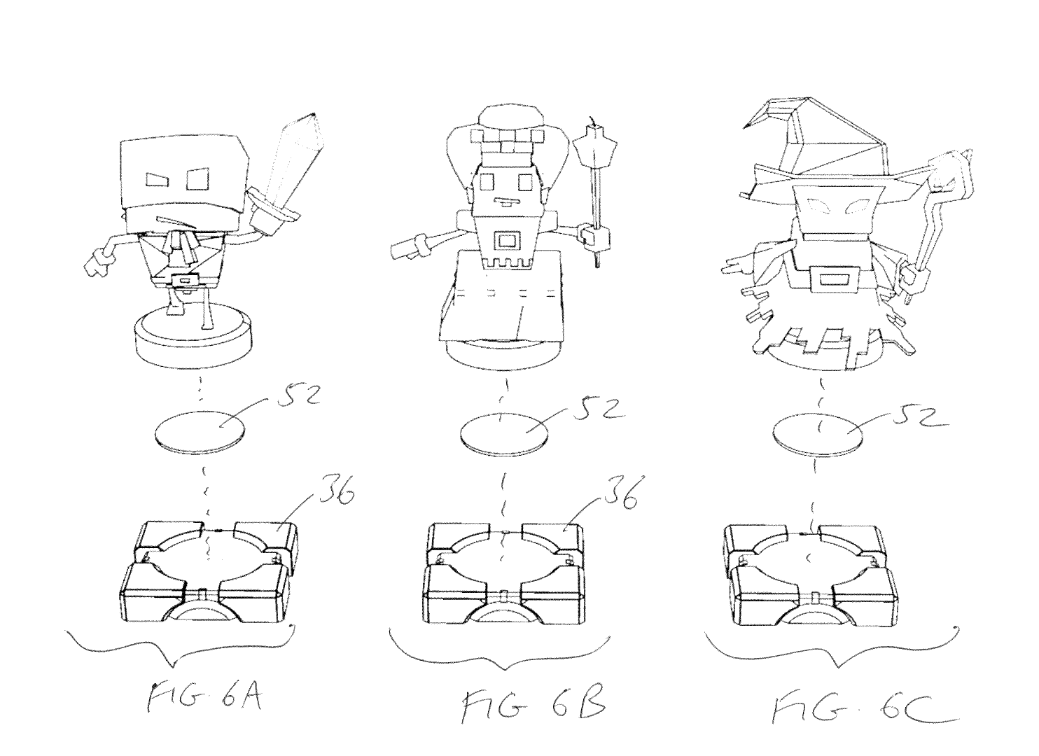

FIGS. 5-7 illustrate another embodiment of the present invention. In FIGS. 5-6C, the support section 12 can be a housing that retains a circuit board 50 inside. The circuit board 50 can include a circuitry that is adapted to communicate with the circuitry on the circuit board 52 inside the base 36 of the play objects 14a-14c.

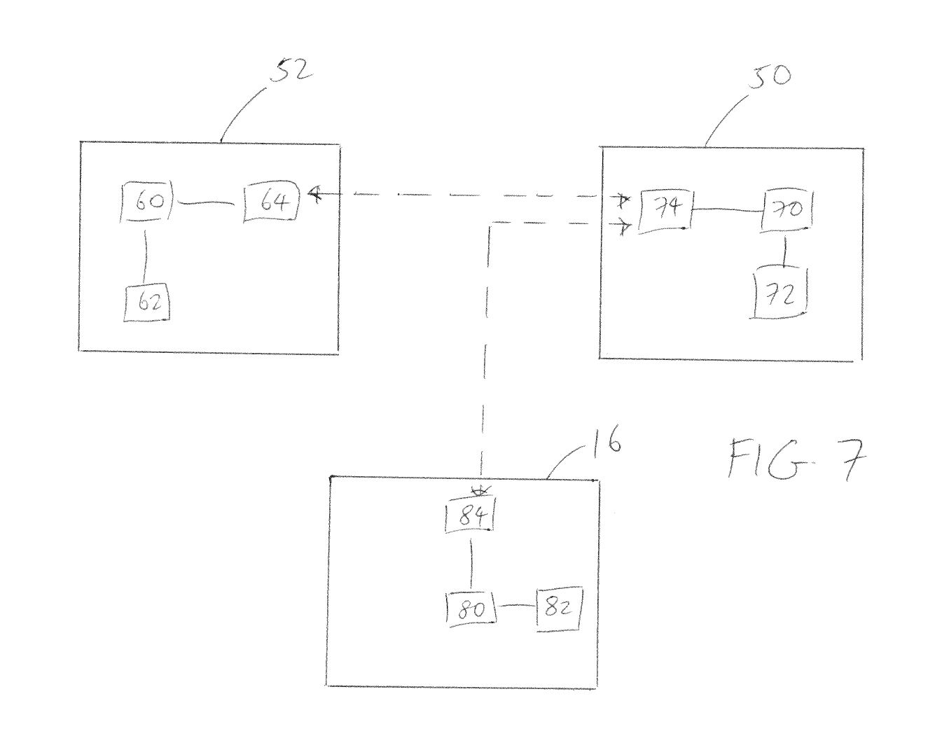

Referring to FIG. 7, the circuit board 52 in each play object 14a-14c can include a processor 60, a memory 62 and an antenna 64. The memory 62 can store codes that identify the play object, as well as data that contain details or characteristics of the play object. Alternatively, the memory 62 can include a radio-frequency identification (RFID) tag that stores identification for the object. Similarly, the circuit board 50 in the support section 12 can include a processor 70, a memory 72 and an antenna 74. The memory 72 can store programs, codes, and other data. The circuit board 50 can also include an RFID reader coupled to the antenna 74 for reading the RFID tag on the circuit board 52. In use, when the play objects 14a-14c have been coupled to the support section 12, the processor 60 can communicate with the processor 70 via the antennas 64 and 74. The processor 60 can access the codes and data in the memory 62, and provide them to the processor 70. The processor 70 can then access the programs and other data in the memory 72, and send appropriate signals via its antenna 74 to the tablet 16. The tablet 16 can also have a processor 80, a memory 82 and an antenna 84. The signals communicated from the antenna 74 are received at the tablet 16 via the antenna 84 and the processed by the processor 80. Alternatively, if the objects 14a-14c are provided with RFID tags, the RFID reader on the circuit board 50 can read the identification signals and communicate via conventional BLUETOOTH™ technology with the tablet 16. The signals received by the tablet 16 can trigger an activity (such as stories, games, reading a book, etc.) with the character or object displayed on the tablet 16 during the activity.

For example, when the play object 14a has been coupled to the support section 12, it communicates its identity to the processor 70 in the support section 12, which then communicates this identity to the processor 80 in the tablet 16. With the downloaded application being enabled, the application will recognize the identity of the play object 14a, and enable an activity (e.g., game, story, video, song, etc.) relating to that play object 14a to be played by a user on the tablet 16. At this point, the processor 80 can request additional data (e.g., code, details, etc.) from the processor 60 via the processor 70, and the processor 60 can access the memory 62 for the requested data and transfer the data back to the processor 80. A variety of activities can be played through the back-and-forth communication between the play object and the application running on the tablet 16, using the circuit board 50 in the support section 12 as an intermediary. The play object 14a can be displayed on the tablet 16 during the activity, and interacts with the user during the activity.

The user can also participate and make the activity more interactive. For example, if the activity is a game, the user can cause the image of the play object to move, to engage in specific acts, or be involved in the game in any known manner. If the activity is the reading of a book or the playing of a song, the user can make the image of play object to engage in certain acts or activities during the reading of the book or playing of the song by selecting certain options, or by directly manipulating the position of the image of the play object on the screen of the smart device. Such manipulation can also enable different functionalities. For example, during a game, a song or reading is enabled if the user manipulates the image in a certain way, or selects certain controls. These activities can be provided by software on the selected “App”, and/or the data or other information stored in any of the memories 62 or 72.

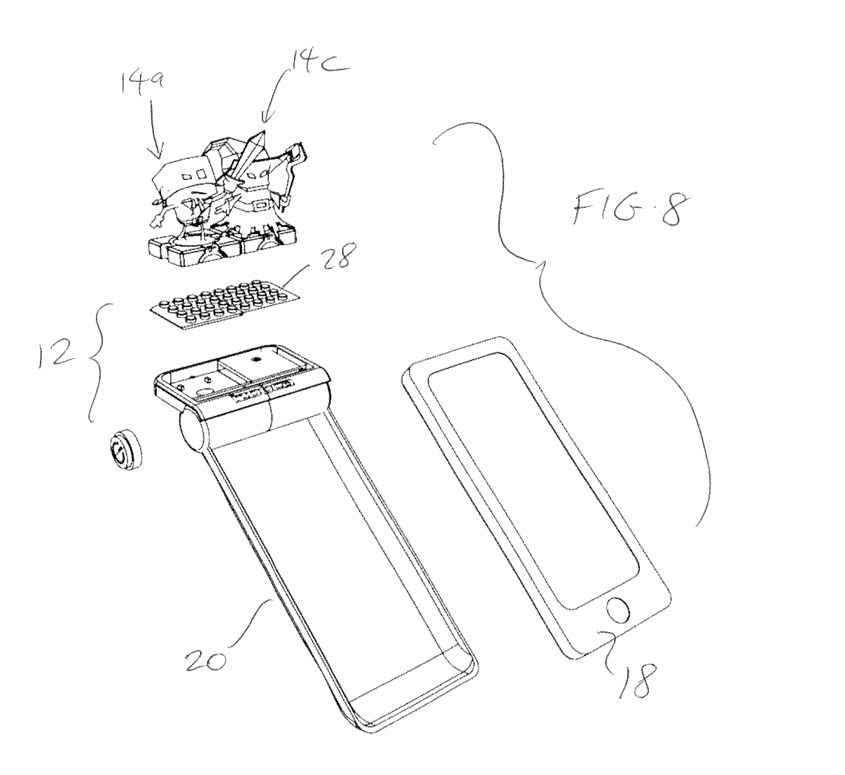

Even though the present invention has been described in a connection with a tablet 16, it is also possible to apply the principles herein to a holder for a smartphone. FIG. 8 illustrates a holder 10 that can be used with a smartphone 18.

Thus, the present invention provides a multi-purpose holder that can be used with a tablet or smartphone, which allows objects to be supported on the holder. This enhances the enjoyment and utility of the tablet or smartphone by enhancing a game or activity that is being played on the tablet or smartphone. The holder can also function to prop up the tablet smartphone at an angle to facilitate convenient viewing.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An assembly, comprising:
a smart device having a housing;
a play object having a base with a first connector on the base;
a holder having a frame section that securely receives and retains the housing of the smart device, and a support section extending from the frame section, the support section having a second connector that is adapted to couple to the first connector on the base.

2. The assembly of claim 1, wherein the support section has a first edge and an opposing second edge that is connected to the frame section at an angle, such that the frame section is propped at an angle when the first edge of the support section rests on a surface.

3. The assembly of claim 1, wherein the support section houses a first circuitry, and wherein the base of the play object houses a second circuitry that communicates with the first circuitry.

4. The assembly of claim 3, wherein the first circuitry includes a memory that stores the identity of the play object, and means for communicating the identity of the play object to the second circuitry.

5. An interactive play method, comprising:
providing a smart device having a housing, with a smart device circuitry housed therein;
providing a play object having a base, and a first circuitry inside the base, the first circuitry including a memory that stores the identity of the play object;
providing a holder having a frame section that securely receives and retains the housing of the smart device, and a support section extending from the frame section, the support section having a second circuitry inside the support section;
coupling the base of the play object to the support section;
communicating the identity of the play object from the first circuitry to the second circuitry;
communicating the identity of the play object from the second circuitry to the smart device circuitry; and
based on the identity of the play object, initiating an activity on the smart device.

6. The method of claim 5, wherein the activity is a game, reading of a book, playing of a video, or playing of a song.

7. The method of claim 5, further including displaying the play object on the smart device during the activity.

8. The method of claim 7, further including manipulating the image of the play object displayed on the smart device during the activity to enable additional functionalities.

9. The method of claim 5, wherein the communicating steps are accomplished via BLUETOOTH™.
